(19) United States
(12) Patent Application Publication
(10) Pub. No.: US 2009/0241118 A1
(43) Pub. Date: Sep. 24, 2009

(54) SYSTEM AND METHOD FOR PROCESSING INTERFACE REQUESTS IN BATCH

(75) Inventor: Krishna K. Lingamneni, Phoenix, AZ (US)

Correspondence Address: Snell & Wilmer L.L.P. (AMEX), ONE ARIZONA CENTER, 400 E. VAN BUREN STREET, PHOENIX, AZ, 85004-2202, US

(73) Assignee: American Express Travel Related Services Company, Inc., New York, NY (US)

(21) Appl. No.: 12/052,644

(22) Filed: Mar. 20, 2008

(51) Int. Cl. G06F 9/46

(52) U.S. Cl. 718/101

(57) ABSTRACT

A batch messaging management system configured to process incoming request messages and provide reply messages in an efficient manner is disclosed. Instead of treating individual requests as individual transactions, the system reduces processing overhead within a mainframe computing environment by storing requests within a queue, spawning batch jobs according to the queue and processing multiple transactions using batch job processing.

### FIELD OF INVENTION

The present invention generally relates to a batch messaging management system within a mainframe computing environment, and more particularly, to systems and methods for increasing processing efficiency by processing real-time requests using batch jobs within a mainframe environment.

### BACKGROUND OF THE INVENTION

Despite innovations leading to more robust and efficient computing systems and software, the role of mainframe computing remains vital to many businesses and organizations. One example of such mainframe technology is IBM's Customer Information Control System (CICS). CICS is a transaction process monitor that was originally developed to provide transaction processing for IBM mainframes. It controls the interaction between applications and users, and allows programmers to develop screen displays without detailed knowledge of the terminals being used. According to the CICS architecture, transactions are executed to process a single request per CICS transaction, thereby incurring increased overhead wherein the overhead may include, for example, starting up a transaction for every single request, CPU costs, etc.

In most cases, mainframe computing systems that are in use today were originally implemented prior to the computing innovations of the 1980's and 90's. However, many businesses and organizations have concluded that it would be too expensive and too intrusive to day-to-day business operations to upgrade their major systems to newer technologies. Therefore, to enable continued expansion of computing infrastructures to take advantage of newer technologies, much effort has been devoted to developing ways to integrate older mainframe technologies with newer server and component based technologies. Moreover, methods have been developed to add functionality to mainframe computers that were not previously available, along with increasing processing speed and efficiency.

Therefore, a need exists for a system and method for increasing computing efficiency and speed within a mainframe environment such that individual CICS requests are typically processed as individual CICS transactions. In order to process requests and provide reply messages in the shortest time possible and at the lowest cost, there is a need for a system that processes messages outside of the CICS environment, with minimal or no impact on user response times or otherwise sufficiently degrading overall system performance.

### SUMMARY OF THE INVENTION

The invention includes a batch messaging management system (“BMMS”) to overcome the disadvantages of traditional real-time request processing architectures. In one embodiment, a series of batch jobs are executed concurrently and the system processes real-time requests from interfacing applications to provide a near real-time response. This solution runs the optimal number of jobs in order to provide a timely reply to the requesting applications. A spawning architecture runs the optimal number of jobs to process the request messages rapidly and efficiently.

In one embodiment, the invention provides a method of processing real-time message requests with minimal or no use of traditional mainframe online transaction environments such as CICS or IMS. As such, the invention overcomes the limitations of the traditional CICS messaging architecture by, for example, reducing the overhead cost of starting new transactions.

More particularly, the invention increases messaging efficiency for transactions (that were previously executed to process a single request per CICS transaction), thereby reducing processing overhead. In one embodiment, the invention includes a BMMS using a batch processing solution. The invention processes the request messages originating from any number of interfaces, and provides reply messages in a timely and cost efficient manner. The invention executes batch jobs to process multiple message requests concurrently as they arrive. This batch approach may, for example, process the messages in a cost-efficient manner, increase system processing capacity, decrease the average CPU resources consumed during message processing, reduce processing bottlenecks, increase throughput, quickly process message requests with reduced response times and fewer timeouts, and cut in half the CPU costs related to processing. While the method may be described with respect to replacing processing messages using CICS transactions, the method contemplates using batch jobs in lieu of other types of transactions that expect real-time, or near real-time, response.

The BMMS includes job spawning logic, which reacts to the message arrival rate in order to maintain the right number of active batch jobs. When there is a need to spawn additional jobs to correspond with an increase in the arrival rate of the messages, the BMMS starts new jobs. More specifically, the system manages the number of currently executing batch jobs and submits a real-time request as a batch job that executes business logic corresponding at least in part to the content of the request. The request may originate from an upstream or requesting system and may be stored in a request queue. The system receives output from the batch jobs, formats a reply message and stores the reply message in an accessible reply queue.

### BRIEF DESCRIPTION OF THE DRAWINGS

A more complete understanding of the present invention may be derived by referring to the detailed description and claims when considered in connection with the Figures, wherein like reference numbers refer to similar elements throughout the Figures, and:

FIG. 1 is a combination block diagram and flowchart illustrating an exemplary architecture for processing real-time messages using batch processing, according to one embodiment of the present invention;

FIG. 2 is a flowchart illustrating a view of representative message processing, according to one embodiment of the present invention;

FIG. 2a is a flowchart illustrating a view of representative message processing according to one embodiment of the present invention that manages the spawning process using a frequency function; and

FIG. 3 is a flowchart illustrating a detailed view of a representative spawning process, according to one embodiment of the present invention.

### DETAILED DESCRIPTION

The detailed description of exemplary embodiments of the invention herein makes reference to the accompanying figures, which show the exemplary embodiment for purposes of illustration and its best mode, and not of limitation. While these representative embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process descriptions may be executed in any order and are not limited to the order presented. References to singular include plural, and references to plural include singular.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one embodiment, the system and method processes real-time requests (also referred to as “interface requests”) using batch processing. The message management may be within a mainframe environment through a BMMS that is configured to, for example, interface with a message queue manager, spawn jobs in response to request volume and/or to process one or more messages through a single batch job. While the system may contemplate upgrades or reconfigurations of existing processing systems, changes to existing databases and business information system tools are not necessarily required by the present invention. For example, the present system may contemplate, but does not require, the use of IBM's MQ Series product. Moreover, the system may be seamlessly integrated into existing information technology, data management architectures and business information system tools with minimal or no changes to existing systems.

“Message Queue Manager” or “MQM” may include a network communication software module that allows independent and potentially non-concurrent applications on a distributed system to communicate with each other. MQM functionality includes message input and output queue management, message queuing interfaces, and other message-oriented middleware and message delivery assurance functions. MQM functionality may be custom-built software and it is also available commercially through products such as, for example, IBM's Websphere MQ (often referred to as MQ or MQ Series).

“Entity” may include any individual, consumer, customer, group, business, organization, government entity, transaction account issuer or processor (e.g., credit, charge, etc), merchant, consortium of merchants, account holder, charitable organization, software, hardware, and/or any other entity.

A “financial processor” may include any entity which processes information or transactions, issues accounts, acquires financial information, settles accounts, conducts dispute resolution regarding accounts, and/or the like.

Exemplary benefits provided by this invention include reducing CPU costs, reducing processing overhead (e.g. storage requirements) and enhancing performance associated with online transactions in a mainframe environment. The disclosed BMMS does not incur the overhead cost of starting new transactions as in the case of the traditional online messaging architecture. In one embodiment, the storage is not re-acquired when the modules are executed repeatedly during the processing of multiple messages. As a result, the CPU cost of processing the messages is much lower in this architecture compared to a traditional online architecture. By processing the messages in batch, the overhead involved in starting new CICS transactions is reduced or completely eliminated. For more information regarding CICS architecture and the overhead costs associated with processing interface requests in a CICS environment, please see U.S. patent application Ser. No. 10/906,279, entitled “System And Method For Management Of Requests”, which is hereby incorporated by reference in its entirety.

While described herein in reference to using batch jobs on a mainframe environment instead of incurring the overhead of traditional mainframe online transaction environments, practitioners will appreciate that the invention may further be implemented to provide real-time, or near real-time, response to message requests on other computing platforms, such as mid-range computers.

While the description makes reference to specific technologies, system architectures and data management techniques, practitioners will appreciate that the embodiments disclosed herein are examples and that other devices and/or methods may be implemented without departing from the scope of the invention. Similarly, while the description makes frequent reference to a web client, practitioners will appreciate that other examples of user interfaces that submit messaging requests may be accomplished by using a variety of user interfaces including handheld devices such as personal digital assistants and cellular telephones. Practitioners will also appreciate that a web client is but one embodiment and that other devices and/or methods may be implemented without departing from the scope of the invention.

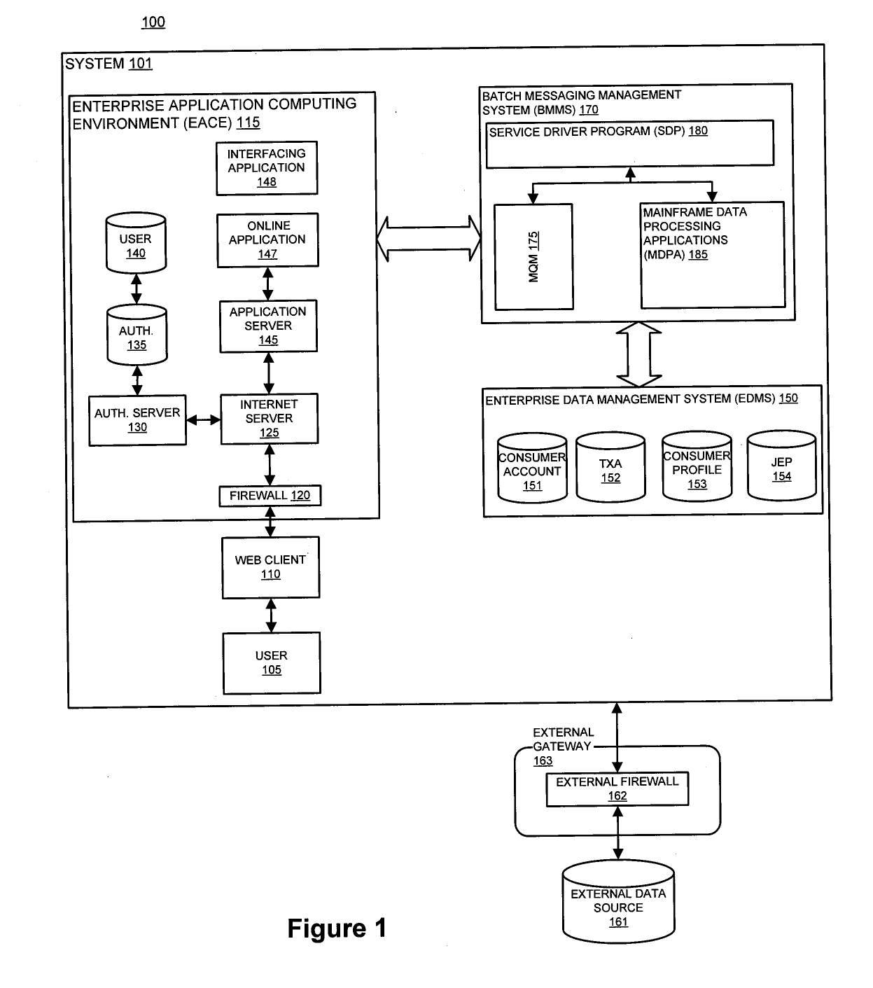

With reference to FIG. 1, the representative system includes a user 105 interfacing with an enterprise application computing environment (“EACE”) 115 by way of a web client 110. A user is any individual, entity, organization, third-party entity, software and/or hardware that interfaces with EACE 115 to access applications or data. User 105 may interface with Internet server 125 via any communication protocol, device or method discussed herein, known in the art, or later developed. In one embodiment, user 105 may interact with the EACE 115 via an Internet browser at a web client 110.

Transmissions between the user 105 and the Internet server 125 may pass through a firewall 120 to help ensure the integrity of the EACE 115 components. Practitioners will appreciate that the invention may incorporate any number of security schemes or none at all. In one embodiment, the Internet server 125 receives page requests from the web client 110 and interacts with various other system 100 components to perform tasks related to requests from the web client 110. Internet server 125 may invoke an authentication server 130 to verify the identity of user 105 and assign specific access rights to user 105. Authentication database 135 may store information used in the authentication process such as, for example, user identifiers, passwords, access privileges, user preferences, user statistics, and the like. When a request to access system 100 is received from Internet server 125, access system 100 determines if authentication is required and transmits a prompt to the web client 110. User 105 enters authentication data at the web client 110, which transmits the authentication data to Internet server 125. Internet server 125 passes the authentication data to authentication server which queries the user database 140 for corresponding credentials. When user 105 is authenticated, user 105 may access various applications and their corresponding data sources.

When user 105 logs on to an application, Internet server 125 may invoke an application server 145. Application server 145 invokes logic in the online application 147 by passing parameters relating to the user's 105 requests for data.

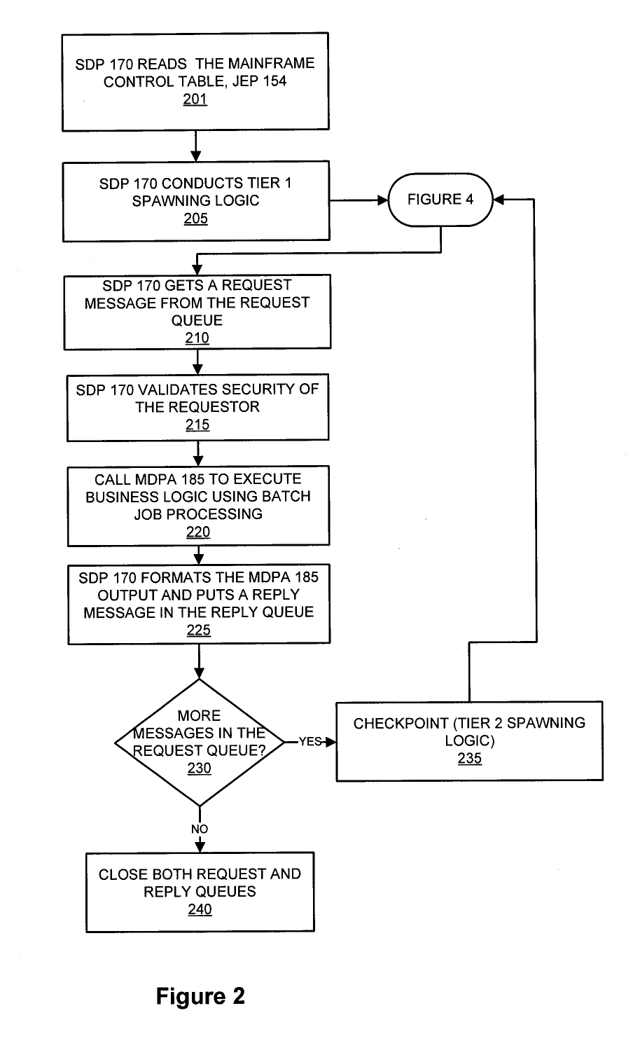

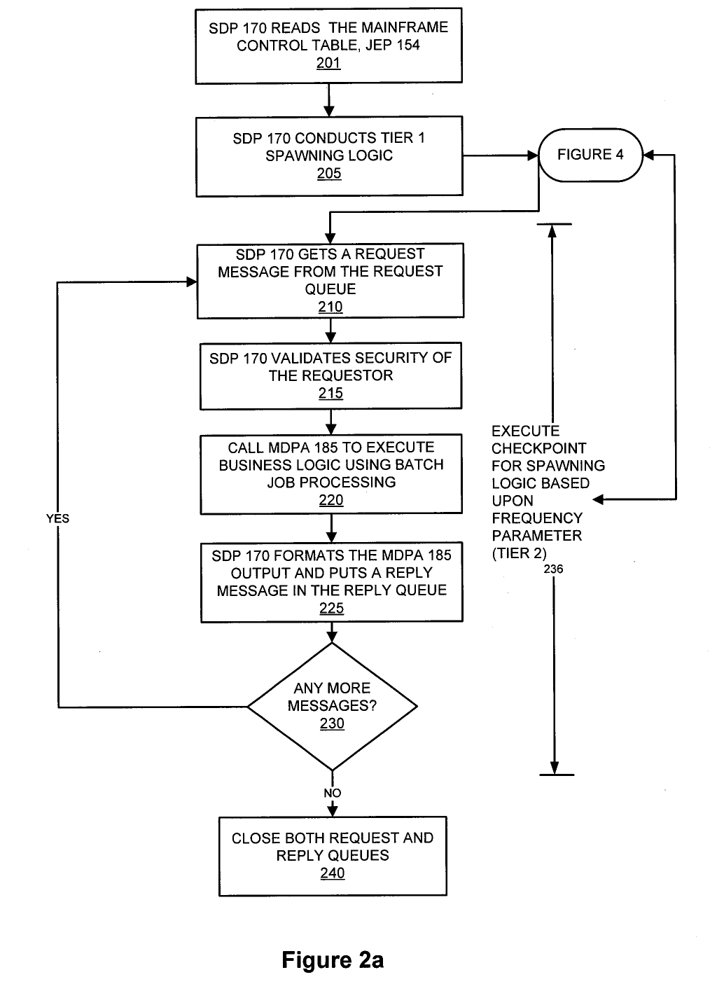

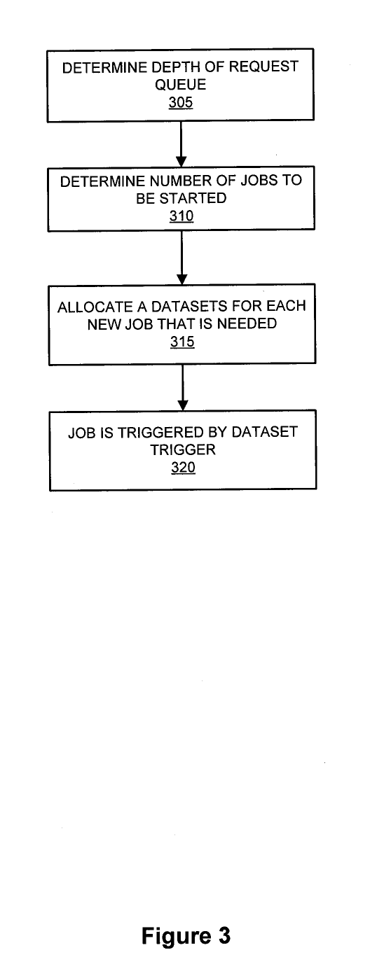

As discussed in further detail in the process descriptions of FIGS. 2, 2a and 3 below, EACE 115 components (e.g. online application 147), interface with the BMMS 170 through the MQM 175. In an embodiment shown in FIG. 1, the BMMS 170 includes the MQM 175, the service driver program (“SDP”) 180 and the mainframe data processing applications (MDPA) 185. However, as practitioners will appreciate, BMMS 170 may include a physical coupling or represent a logical relationship. Therefore, embodiments may include all or none of the illustrated components without departing from the scope of the invention. For instance, in one embodiment, the MQM 175 is a component separate from BMMS 170.

The SDP 180 includes an application module that manages the processing of interface message requests. In the representative embodiment, SDP 180 communicates with MQM 175 to get requests and deliver responses to the various MQM 175 message queues. SDP 180 also communicates with internal mainframe control tables to determine the number of jobs currently running and to determine the correct amount of mainframe batch jobs that should be running at any given time. SDP 180 executes logic to allocate datasets, spawn mainframe jobs and/or conduct error processing. In one embodiment, SDP 180 is a batch job running on the mainframe.

Among other functions, MQM 175 maintains a variety of request and response message queues and is enabled to interface with various components of system 101 including the BMMS 170, online application 147 and interfacing application 148.

MDPA 185 includes software modules that are executed in the mainframe environment. MDPA 185 includes modules that execute data queries, business logic, transactions, calculations, data transformations and the like. In one embodiment, SDP 180 initiates batch jobs to execute MDPA 185 logic using, as part of the job parameters, data from the messages requests obtained from interfacing systems by way of MQM 175.

The online application 147 may include any hardware and/or software suitably configured to receive requests from the web client 110 via Internet server 125 and the application server 145. Online application 147 may communicate with (e.g. submit requests and receive responses) BMMS 170, MQM 175 or any other system 101 component. The interfacing application 148 may include any hardware and/or software component suitably configured to receive requests from a requesting system or user, independently generate requests and communicate with (e.g. submit requests and receive responses) BMMS 170, MQM 175 or any other system 101 component. The online application 147 and the interfacing application 148 are further configured to process requests, construct database queries, and/or execute queries against databases, external data sources and temporary databases, as well as exchange data with other application modules (not pictured). In one embodiment, the online application 147 and the interfacing application 148 may be configured to interact with other system 100 components to perform complex calculations, retrieve additional data, format data into reports, create XML representations of data, construct markup language documents, and/or the like. Moreover, the online application 147 and the interfacing application 148 may reside as a standalone system or may be incorporated with the application server 145 or any other EACE 115 component as program code.

As practitioners will appreciate, while depicted as a single entity for the purposes of illustration, exemplary databases depicted in FIG. 1 may represent multiple physical and/or hardware, software, database, data structure and networking components. FIG. 1 depicts the types of databases that are included in an exemplary embodiment. The customer account database 151 stores tracking information, such as, for example, account numbers and receivable records, regarding customer accounts. The transaction account (“TXA”) database 152 stores financial and other customer transactional information. The customer profile database 153 stores demographic information regarding customers and potential customers.

As practitioners will appreciate, certain embodiments may access data from any external data source that provides useful and accurate data. For instance the EACE 115, EDMS 150 or any other system 100 component may be interconnected to an external data source 161 via a second network, referred to as the external gateway 163. The external gateway 163 may include any hardware and/or software suitably configured to facilitate communications and/or process transactions between the EACE 115 and the external data source 161. Interconnection gateways are commercially available and known in the art. External gateway 163 may be implemented through commercially available hardware and/or software, through custom hardware and/or software components, or through a combination thereof. External gateway 163 may reside in a variety of configurations and may exist as a standalone system or may be a software component residing either inside system 100, the external data source 161 or any other known configuration. External gateway 163 may be configured to deliver data directly to system 100 components (such as online application 147) and to interact with other systems and components such as EACE 115, EDMS 150 or any other system 100. In one embodiment, the external gateway 163 may comprise web services that are invoked to exchange data between the various disclosed systems. The external gateway 163 represents existing proprietary networks that presently accommodate data exchange for data such as financial transactions, customer demographics, billing transactions and the like. The external gateway 163 may be a closed network that is assumed to be secure from eavesdroppers.

As practitioners will appreciate, embodiments are not limited to the exemplary databases described above, nor do embodiments necessarily utilize each of the disclosed exemplary databases. In addition to the components described above, the system 100, the BMMS 170 and the EACE 115 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more system 100 components may be embodied as a customization of an existing system, an add-on product, upgraded software, a stand-alone system (e.g., kiosk), a distributed system, a method, a data processing system, a device for data processing, and/or a computer program product. Accordingly, individual system 100 components may take the form of an entirely software embodiment, an entirely hardware embodiment, or an embodiment combining aspects of both software and hardware. Furthermore, individual system 100 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The systems and methods contemplate uses in association with financial processor back office systems, billing systems, accounts receivable systems, operational management systems, cash management tools, logistical planning tools, business intelligence systems, reporting systems, web services, pervasive and individualized solutions, open source, biometrics, mobility and wireless solutions, commodity computing, grid computing and/or mesh computing. For example, in an embodiment, the web client 110 is configured with a biometric security system that may be used for providing biometrics as a secondary form of identification. The biometric security system may include a transaction device and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

Web client 110 comprises any hardware and/or software suitably configured to facilitate requesting, retrieving, updating, analyzing, entering or modifying data such as marketing data or any information discussed herein. Web client 110 includes any device (e.g., personal computer), which communicates (in any manner discussed herein) with the EACE 115 via any network discussed herein. Such browser applications comprise Internet browsing software installed within a computing unit or system to conduct online transactions and communications. These computing units or systems may take the form of a computer or set of computers, although other types of computing units or systems may be used, including laptops, notebooks, hand-held computers, set-top boxes, workstations, computer-servers, mainframe computers, mini-computers, PC servers, pervasive computers, network sets of computers, and/or the like. Practitioners will appreciate that the web client 110 may or may not be in direct contact with the EACE 115. For example, the web client 110 may access the services of the EACE 115 through another server, which may have a direct or indirect connection to Internet server 125.

As those skilled in the art will appreciate, the web client 110 includes an operating system (e.g., Windows NT, 95/98/2000, OS2, UNIX, Linux, Solaris, MacOS, etc.) as well as various conventional support software and drivers typically associated with computers. Web client 110 may include any suitable personal computer, network computer, workstation, mini-computer, mainframe, mobile device or the like. Web client 110 can be in a home or business environment with access to a network. In an embodiment, access is through a network or the Internet through a commercially available web-browser software package.

Web client 110 may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network.

Firewall 120, as used herein, may comprise any hardware and/or software suitably configured to protect the EACE 115 components from users of other networks. Firewall 120 may reside in varying configurations including stateful inspection, proxy-based and packet filtering, among others. Firewall 120 may be integrated as software within Internet server 125, any other system components, or may reside within another computing device or may take the form of a standalone hardware component.

Internet server 125 may include any hardware and/or software suitably configured to facilitate communications between the web client 110 and one or more EACE 115 components. Further, Internet server 125 may be configured to transmit data to the web client 110 within markup language documents. As used herein, “data” may include encompassing information such as commands, queries, files, data for storage, and/or the like in digital or any other form. Internet server 125 may operate as a single entity in a single geographic location or as separate computing components located together or in separate geographic locations.

Internet server 125 may provide a suitable web site or other Internet-based graphical user interface, which is accessible by users. An Internet server may provide a suitable web site or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system. In one embodiment, the Apache web server is used in conjunction with a Linux operating system, a MySQL database, and/or the Perl, PHP, and Python programming languages.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), Microsoft .NET Framework, common gateway interface scripts (CGI), extensible markup language (XML), dynamic HTML, AJAX (Asynchronous Javascript And XML), cascading style sheets (CSS), helper applications, plug-ins, and/or the like. A server may include a web service that receives a request from a web server, the request including a URL (http://yahoo.com/stockquotes/ge) and an IP address (123.56.789). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, AJAX, WSDL and UDDI. Web services methods are well known in the art, and are covered in many standard texts. See, e.g., Alex Nghiem, IT Web Services: A Roadmap For The Enterprise (2003) Or Web Services Architecture, W3C Working Group Note 11 Feb. 2004, available at http://www.w3.org/TR/2004/NOTE-ws-arch-20040211, both of which are hereby incorporated by reference.

Application server 145 may include any hardware and/or software suitably configured to serve applications and data to a connected web client 110. Like Internet server 125, the application server 145 may communicate with any number of other servers, databases and/or components through any means known in the art. Further, the application server 145 may serve as a conduit between the web client 110 and the various systems and components of the EACE 115. Internet server 125 may interface with the application server 145 through any means known in the art including a LAN/WAN, for example. Application server 145 may further invoke software modules such as the online application 147 in response to user 105 requests.

In order to control access to the application server 145 or any other component of the EACE 115, Internet server 125 may invoke an authentication server 130 in response to user 105 submissions of authentication credentials received at Internet server 125. Authentication server 130 may include any hardware and/or software suitably configured to receive authentication credentials, encrypt and decrypt credentials, authenticate credentials, and/or grant access rights according to pre-defined privileges attached to the credentials. Authentication server 130 may grant varying degrees of application and data level access to users based on information stored within the user database 140.

Any database depicted or implied by FIG. 1 may include any hardware and/or software suitably configured to facilitate storing identification, authentication credentials, and/or user permissions. One skilled in the art will appreciate that system 100 may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), Microsoft Office SharePoint Server, or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a key field in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In an embodiment, the ability to store a wide variety of information in different formats is facilitated by storing the information as a BLOB. Thus, any binary information can be stored in a storage space associated with a data set. As discussed above, the binary information may be stored on the financial transaction instrument or external to, but affiliated with, the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second parties. Each of the three data sets in this example may contain different information that is stored using different data storage formats and/or techniques. Further, each data set may contain subsets of data that also may be distinct from other subsets.

As stated above, in various embodiments of system 100, the data can be stored without regard to a common format. However, in one embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. System 100 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 100 may consist of any combination thereof at a single location or at multiple locations, wherein each database or system includes any of various suitable security features, such as firewalls, access codes, encryption, decryption, compression, decompression, and/or the like.

The invention may be described herein in terms of functional block components, screen shots, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and/or the like, which may carry out a variety of functions under the control of one or more microprocessors or other control devices. Similarly, the software elements of system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that system 100 may employ any number of conventional techniques for data transmission, signaling, data processing, network control, and/or the like. Still further, system 100 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (Second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

Referring now to the figures, the block system diagrams and process flow diagrams represent mere embodiments of the invention and are not intended to limit the scope of the invention as described herein. For example, the steps recited in FIGS. 2, 2a and 3 may be executed in any order and are not limited to the order presented. It will be appreciated that the following description makes appropriate references not only to the steps depicted in FIGS. 2, 2a and 3, but also to the various system components as described above with reference to FIG. 1.

FIG. 2 is a flowchart illustrating a representative batch message processing, according to one embodiment of the present invention. The SDP 180 retrieves job execution parameters from the JEP database 154 (step 201). In one embodiment, there is a separate SDP 180 software module for each type of application that may be invoked by a request message. For example, separate SDP 180 software instances may be invoked to service requests for transactional data and for customer profile data. In this example, the SDP 180 retrieves the parameters from JEP database 154 that correspond to the MDPA module that is to be executed in order to service the interface request. The SDP 180 executes initial spawning logic to determine if or when new batch jobs are needed to process the request message (Step 305).

A process flow diagram of representative spawning logic is depicted in FIG. 3. The number of request messages in the queue (“request queue depth”) is determined (step 305) based upon, for example, the request queue depth, a number of jobs to be started to maintain or increase overall processing efficiency and user response time is calculated (step 310). The number of new batch jobs to be started depends on current queue depth and is determined as a function of (e.g. equal to, proportional to, etc.) the number of jobs executing in the system. In one embodiment, the request queue depth determines the number of jobs that should be running to process the request messages in a timely manner. The JEP database 154 stores several ranges indicating how many jobs should be running when the request queue depth is at a particular level. For example, when the request queue depth is between 100 and 200, the JEP database 154 may indicate that the number of jobs running in the system should be 10. If 10 jobs are not running at that point of time, then the appropriate jobs would be started. If new jobs are to be started, a dataset is allocated (step 315) and a new job is created by a dataset trigger mechanism (step 320). In one embodiment, jobs are invoked directly and do not utilize a dataset trigger mechanism.

Referring again to FIG. 2, the SDP 180 gets the request message (step 210). Security validation is performed on the requesting user 105 (step 215). SDP 180 formats the message and calls the MDPA 185 module to process the request. MDPA 185 is executed by a batch job (step 220). SDP 180 formats the output of the batch job and puts a reply message in the MQM 175 reply queue (step 225). The SDP 180 manages the interface with MQM 175 to maintain processing efficiency. For example, in one embodiment, the MQM 175 interface module does not open and close the queue for every message it processes, it opens the queue and stores the object handle and uses the object handle for processing all the messages.

In one embodiment, the MDPA 185 modules are computer programs configured to run in the mainframe environment and SDP 180 formats the request such that the MDPA 185 module is executed by a batch job. For example, a user 105 may access the requesting application 147 via the web client 110 in order to obtain information regarding, for example, user 105's account. Requesting application 147 submits a real-time request for transaction information about a particular account. As practitioners will appreciate, the application providing an interface request may request, either explicitly or implicitly, that the output or result of the request be delivered or made available to a different application or user. In one embodiment, the interfacing application 148 is an internal application used by an entity's customer service group. A customer calls a customer service representative to request information about the customer's account. The customer service representative initiates a request message using interfacing application 148 and the output of the request is made available to requesting application 147 which is a software module that delivers information to the customer through a web-based portal.

The BMSS 170 handles the message requests, which often expect a real-time response, by executing a batch job on the mainframe. An MDPA 185 program configured to access the TXA database 152 is executed by a batch job on the mainframe and produces output corresponding to the user 105 request for transaction information. The SDP 180 formats a reply message in a form that is at least in part determined by the content of the request. In one embodiment, SDP 180 also formats the batch job output (i.e. the actual business, functional or real-world data that is being sought by the user 105) into a form that is at least in part determined by the content of the request. SDP 180 puts the reply message into the MQM 175 reply queue (step 225). If the MQM 175 request queue is empty or low (step 230), the SDP causes the MQM 175 queues to close (step 240). However, if the MQM 175 request queue still contains messages (or less than a predetermined amount of messages) (step 230), the process iterates.

In the representative embodiment depicted in FIGS. 2 and 2a, the spawning mechanism is controlled by the SDP 175 which executes the spawning process at 2 levels (“2-tier spawning mechanism”). The Tier 1 spawning process occurs in the initial part of the process (step 205). SDP 180 executes the Tier 2 spawning process by “taking a checkpoint;” that is, periodically checking whether new jobs are needed (step 235 in FIG. 2 and step 236 in FIG. 2a). As practitioners will appreciate, taking a checkpoint may be triggered according to a variety of strategies. In the embodiment of FIG. 2, a checkpoint is triggered when processing reaches and/or completes a certain step (step 235). In the embodiment of FIG. 2a, the checkpoint is triggered based upon a frequency function and may occur at any point during the process (step 236). The message processing continues (steps 210-225) until the MQM 175 request queue is empty (step 230).

While the steps outlined above represent a specific embodiment of the invention, practitioners will appreciate that there are any number of computing algorithms and user interfaces that may be applied to create similar results. The steps are presented for the sake of explanation only and are not intended to limit the scope of the invention in any way.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above. Reference to an element in the singular is not intended to mean “one and only one” unless explicitly so stated, but rather “one or more.” Moreover, where a phrase similar to ‘at least one of A, B, and C’ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

1. A method for facilitating a reply to a real-time request, the method including:
managing the number of currently executing batch jobs;
submitting the request as a batch job, wherein the batch job executes business logic corresponding at least in part to the request, wherein the request was received from a requesting application and stored into a request queue;
receiving an output of the batch job;
formatting a reply message corresponding to the request; and,
storing the reply message in an accessible reply queue.

2. The method of claim 1, wherein the managing step further includes spawning new jobs to process the request.

3. The method of claim 1, wherein the managing step further includes spawning new jobs to process the request, wherein the number of new jobs is based upon the currently executing batch jobs.

4. The method of claim 1, wherein the managing step further includes spawning new jobs to process the request, wherein the number of new jobs is based upon the depth of the request queue.

5. The method of claim 1, wherein the managing step further includes spawning new jobs to process the request, wherein the number of new jobs is based on a pre-defined equation.

6. The method of claim 1, wherein the managing step further includes spawning new jobs to process the request, wherein the number of new jobs is based on a pre-defined parameter.

7. The method of claim 1, wherein the managing step further includes spawning new jobs to process the request, wherein the spawning logic execution is initiated according to a frequency function.

8. The method of claim 1, wherein the managing step further includes spawning new jobs to process the request, wherein the spawning logic execution is triggered by an event.

9. The method of claim 1, wherein the formatting step further includes formatting a reply message corresponding to at least one of: the business logic and the output.

10. The method of claim 1, wherein the formatting step further includes adding data from the output to the reply message.

11. The method of claim 1, wherein the accessible reply queue is accessible to the requesting application.

12. The method of claim 1, wherein the accessible reply queue is accessible to an interfacing application.

13. The method of claim 1, wherein said formatting further includes processing errors occurring during said formatting of said reply message.

14. The method of claim 1, further including validating an identity of said user based upon authentication credentials imbedded in said request.

15. A method for receiving a reply to a real-time request, the method including:
submitting the request to a receiving system, wherein the receiving system:
stores the request in a request queue;
manages the number of currently executing batch jobs;
submits the request as a batch job, wherein the batch job executes business logic corresponding at least in part to the request;
receives an output of the batch job;
formats a reply message corresponding to the request; and,
stores the reply message in an accessible reply queue;
accessing the reply from the accessible reply queue.

16. A batch messaging system for facilitating a reply to a real-time request, the system configured to:
manage the currently executing batch jobs;
submit the request as a batch job, wherein the batch job executes business logic corresponding at least in part to the request, wherein the request was received from a requesting application and stored into a request queue;
receive an output of the batch job;
format a reply message corresponding to the request; and,
store the reply message in an accessible reply queue.

17. The method of claim 16, wherein a request queue stores the real-time request.

18. The method of claim 16, wherein a message queue manager is configured to manage communication with a request queue and the reply queue.

19. A computer-readable storage medium containing a set of instructions for a general purpose computer configured to:
manage the currently executing batch jobs;
submit the request as a batch job, wherein the batch job executes business logic corresponding at least in part to the request, wherein the request was received from a requesting application and stored into a request queue;
receive an output of the batch job;
format a reply message corresponding to the request; and,
store the output in an accessible reply queue.
